(19) United States
(12) Patent Application Publication
(10) Pub. No.: US 2026/0279237 A1
(43) Pub. Date: Sep. 17, 2026

(54) NON-FRACTIONAL PIXEL SHIFTING TO IMPROVE PIXEL PERFORMANCE

(71) Applicant: GOOGLE LLC, Mountain View, CA (US)

(72) Inventors: Stuart James Myron Nicholson, San Jose, CA (US); Jeffrey Tang Fung Li, Palo Alto, CA (US); Craig Homer Peters, Belmont, CA (US); Robert Lo, San Jose, CA (US); Aurelien Jean Francois David, San Francisco, CA (US)

(21) Appl. No.: 19/168,997

(22) PCT Filed: May 17, 2024
(86) PCT No.: PCT/US2024/029995

§ 371 Date: Sep. 25, 2025

Related U.S. Application Data
(60) Provisional application No. 63/503,311, filed on May 19, 2023.

(51) Int. Cl. G09G 3/00; G09G 3/20

(52) U.S. Cl. CPC G09G 3/007; G09G 3/2022; G09G 2320/0233; G09G 2320/0242; G09G 2330/10

(57) ABSTRACT

Systems and methods for non-fractional pixel shifting are described herein to mitigate pixel performance disparities in display systems. One example display system includes a display for presentation to a user, a pixel panel including a first pixel and a second pixel, and a pixel controller. The first pixel may have a first performance capability with respect to a criterion and the second pixel may have a second performance capability with respect to the criterion. The pixel controller may then cause the display system to present a frame on the display by performing operations including: causing first light emitted by the first pixel to be displayed at a pixel position on the display during presentation of a first subframe of the frame, and causing second light emitted by the second pixel to be displayed at the pixel position on the display during presentation of a second subframe of the frame.

### CROSS REFERENCE TO RELATED APPLICATION

This application claims the benefit of U.S. Provisional Application No. 63/503,311, filed May 19, 2023, the disclosure of which is incorporated herein by reference in its entirety.

### BACKGROUND

Digitally-encoded images may be presented to viewers using a variety of different types of displays featured in a variety of different types of devices. For example, personal computing devices (e.g., laptops, tablets, etc.), mobile devices (e.g., smartphones, electronic readers, etc.), wearable devices (e.g., smart watches, etc.), extended reality devices (e.g., virtual and augmented reality headsets, etc.), televisions, and various other devices all feature displays configured to present images to users of the devices. Each of these example displays may use arrays of pixels to present virtually limitless possible images.

### SUMMARY

Despite great care that might be taken in the manufacture of pixel arrays for displays described herein, an expectation that every single pixel will perform identically (or even be functional to perform at all) is unrealistic when large numbers of pixels are manufactured on a given pixel panel. To mitigate performance disparities in neighboring pixels, therefore, implementations described herein employ non-fractional pixel shifting techniques. For example, if a first pixel with normal performance capabilities is adjacent to a second pixel that has some performance defect (e.g., the pixel is non-functional or at least performs sub-optimally), non-fractional pixel shifting techniques may be used to effectively improve the defective pixel, in image frames perceived by a user, by shifting the first pixel to the position of the second pixel for at least a portion of each frame. In this way, a properly functioning pixel may occupy a particular pixel position for at least one subframe of each frame even when an underperforming pixel occupies that pixel position for another subframe of each frame, thereby improving the performance at that pixel position as perceived by the user. For example, light emitted from that pixel position will be perceived as being brighter or otherwise higher performing as compared to a scenario with no pixel shifting (in which the deficient pixel always persists at that position) or as compared to a scenario where the only pixel shifting used is fractional pixel shifting to an offset grid of pixel positions (e.g., using different subframes that are fractionally offset to increase the perceived resolution of the display or to mitigate other issues such as the screen-door effect).

As one example implementation, an illustrative display system may include: 1) a display for presentation to a user; 2) a pixel panel including a first pixel and a second pixel; and 3) a pixel controller configured to cause the display system to present a frame on the display. In this example, the first pixel may have a first performance capability with respect to a criterion (e.g., brightness, efficiency, chromaticity with respect to a nominal color, etc.) and the second pixel having a second performance capability with respect to the criterion. The pixel controller may cause the display system to present the frame by performing operations including: 1) causing first light emitted by the first pixel to be displayed at a pixel position on the display during presentation of a first subframe of the frame; and 2) causing second light emitted by the second pixel to be displayed at the pixel position on the display during presentation of a second subframe of the frame.

As another example implementation, an illustrative method for non-fractional pixel shifting to improve pixel performance may include: 1) presenting, on a display of a display system, a frame that includes a first subframe and a second subframe (wherein the display system may again include the display and a pixel panel including a first pixel having a first performance capability with respect to a criterion and a second pixel having a second performance capability with respect to the criterion); 2) configuring the display system such that first light emitted by the first pixel is displayed at a pixel position on the display during presentation of the first subframe; and 3) configuring the display system such that second light emitted by the second pixel is displayed at the pixel position during presentation of the second subframe.

As yet another example implementation, an illustrative non-transitory computer-readable medium may store instructions that, when executed, cause a pixel controller of a display system to perform a process comprising: 1) presenting, on a display of the display system, a frame that includes a first subframe and a second subframe (wherein the display system may again include the display and a pixel panel including a first pixel having a first performance capability with respect to a criterion and a second pixel having a second performance capability with respect to the criterion); 2) configuring the display system such that first light emitted by the first pixel is displayed at a pixel position on the display during presentation of the first subframe; and 3) configuring the display system such that second light emitted by the second pixel is displayed at the pixel position during presentation of the second subframe.

Various additional operations may be added to these processes and methods as may serve a particular implementation, examples of which will be described in more detail below. Additionally, it will be understood that each of elements described as being part of certain types of implementations in the examples above (e.g., display system components, method steps, process operations, etc.) may additionally or alternatively be included or performed by other types of implementations as well. For example, a process described above as being included in a computer-readable medium could be performed as a method or could be performed by at least one processor of a display system such as described herein. Similarly, the method set forth above could be encoded in instructions stored by a computer-readable medium or could be executed by a display system such as described above.

The details of these and other implementations are set forth in the accompanying figures and the description below. Other features will also be made apparent from the following description, drawings, and claims.

### BRIEF DESCRIPTION OF THE DRAWINGS

FIG. 1 shows aspects of one illustrative implementation of non-fractional pixel shifting to improve pixel performance of a display in accordance with principles described herein.

FIG. 2 shows an illustrative display system configured to perform non-fractional pixel shifting to improve pixel performance in accordance with principles described herein.

FIG. 3 shows an illustrative method for non-fractional pixel shifting to improve pixel performance in accordance with principles described herein.

FIGS. 4A and 4B show aspects of illustrative implementations of non-fractional pixel shifting during presentation of a frame that includes a plurality of subframes in accordance with principles described herein.

FIGS. 5A-5D show a variety of illustrative pixel shifting patterns that may be employed by implementations of non-fractional pixel shifting to improve pixel performance in accordance with principles described herein.

FIG. 6 shows an illustrative image frame being presented by superimposing subframes with fractional and non-fractional pixel shifting to improve pixel performance and achieve other objectives in accordance with principles described herein.

FIG. 7 shows an illustrative computing system that may be used to implement various devices and/or systems described herein.

### DETAILED DESCRIPTION

Systems and methods for non-fractional pixel shifting to improve pixel performance are described herein. In particular, non-fractional pixel shifting described in implementations herein may mitigate pixel performance disparities to improve pixel uniformity, reduce perceivable effects from underperforming pixels, increase yield, and provide other benefits described herein.

Display systems of various types may include arrays of pixels that are used to present images by emitting light at varying frequencies (different colors) and varying luminance (different brightness). In an ideal world, a pixel panel for such a display system might include an array of completely identical pixels, each one capable of performing exactly the same as the others in terms of various performance criteria or figures of merit such as brightness, efficiency, chromaticity (i.e., proximity to a nominal color), and so forth. Unfortunately, various unavoidable challenges of manufacturing and pixel production processes lead to real-world pixel panels that do not exhibit such perfect uniformity as might be desired. Rather, a real-world pixel panel may include pixels that vary widely in their performance capabilities, even for pixels that are directly adjacent to one another. For example, a first pixel that is able to perform adequately (e.g., 100% performance capability) with regard to relevant figures of merit could be adjacent to a second pixel that is able to perform well above the adequate level (e.g., 120% performance capability), which could be adjacent to a third pixel with a performance capability that is almost but not quite adequate (e.g., 90% performance capability), which could be adjacent to a fourth pixel that is completely non-operational (e.g., 0% performance capability).

Such performance disparities, particularly between immediately adjacent pixels (as opposed to performance capability trends that change gradually from, for example, the middle to the edge of a panel or the like) may tend to be particularly pronounced with certain types of pixel panels. For instance, micro-light-emitting-diodes (microLED) panels may be particularly susceptible to pixel performance disparities with neighboring pixels due to certain aspects of how these pixels function and the manufacturing processes used to produce them.

While some number of dead or underperforming pixels on a single panel may be acceptable for certain applications and/or under certain circumstances, any underperforming pixels may detract from the overall quality of experience of viewers of the display, and the tolerance for defective pixels may be limited if any quality of experience is to be guaranteed. Accordingly, as pixel panels and associated displays are produced and tested, the manufacturing yield of these devices may be influenced by defective pixels, since panels with too many defective pixels may fail quality control tests and be discarded. Similarly, the quality provided by these devices may also be influenced by the overall uniformity that the pixel panels can provide, since displays may be forced to operate with reduced performance (e.g., reduced brightness, sub-optimal efficiency, etc.) to ensure that the performance between pixels is suitably uniform.

These varying conditions (e.g., differing performance capabilities, etc.) of different pixels on a given pixel panel create a technical problem for pixel panels that it would be desirable to address without the negative panel yield and performance effects that have been described. Accordingly, implementations described herein provide at least one technical solution to this technical problem of how to mitigate pixel performance disparities (at least as the disparities are perceived by users of display systems). Specifically, implementations described herein relate to non-fractional pixel shifting (also referred to as non-fractional wobulation) whereby the array of pixels is made to shift by whole (non-fractional) pixel distances during the course of presenting each frame. For example, the pixel array may be shifted, for different subframes included within a given frame, so that each pixel moves one, two, three (or another suitable integer) positions up, down, or to the right or left. In this way, the same pixel positions on the display that host underperforming pixels during one part of each frame time (e.g., during the presentation of one subframe) may host functional pixels during another part of the frame time (e.g., during the presentation of another subframe). Thus, for instance, a pixel position that might otherwise always host a dead pixel may only host the dead pixel for half of each frame or less, making the dead pixel less noticeable to a user viewing the display and generally improving the perceived performance of the entire display.

As used herein, underperforming pixels may refer both to pixels that may be completely dead or non-operational (total pixel failure), as well as to pixels that are operational to some degree but at least somewhat lacking in performance capability (e.g., below a desired threshold, etc.) with respect to a particular criterion (e.g., a figure of merit or attribute of interest such as brightness, efficiency, chromaticity, or the like). In contrast, functional pixels, as used herein, may refer to pixels exhibiting performance capabilities (with respect to relevant criteria of interest) that satisfy a particular threshold. For example, pixels of a particular panel may be designed so as to be capable of emitting light at a particular performance level (e.g., brightness level, etc.). If, for instance, this desired level is 10 units, then any pixel not capable of emitting light with at least 10 units of performance would be considered underperforming, while any pixel capable of emitting light with 10 or more units would be considered functional.

On a given panel, a large percentage of the pixels may be functional, including many pixels that may be capable of performing well above the threshold. For instance, referring to this quantitative example of a 10-unit performance threshold, a given pixel panel could have 95% of pixels that are capable of performing with at least 10 units, with 50% of those capable of performing with at least 15 units and 10% of those may be capable of performing with at least 20 units. All of these pixels would be considered functional pixels, despite that there may be a fairly large variation in performance capabilities between them. Likewise, of the 5% of pixels in this example that are incapable of performing with at least 10 units, 20% of those may be capable of performing with at least 8 units, 30% may be capable of performing with at least 5 units, and the remaining 50% may be completely dead. These quantities will be understood to be arbitrary example quantities for illustrative purposes, and, as mentioned above, performance disparities quantified by these examples may arise as a result of manufacturing processes, the nature of how different types of pixel technologies work, and/or other causes. For instance, microLED panels may be especially susceptible to these types of disparities from pixel to pixel, such that it may not be uncommon for an underperforming pixel to be surrounded by functional pixels on all sides, including some pixels that are capable of performing well above the threshold (e.g., 15-20 units in the example described above).

Pixel shifting or wobulation techniques have generally conventionally been employed to achieve technical solutions such as increasing perceived pixel resolution or eliminating the “screen door” effect. For example, by shifting pixels by fractional amounts, an illusion may be created that there is an entire new grid of pixel positions on a display (pixel positions for some subframes that are located in between the pixel positions of other subframes). This may help fill in gaps between pixels (gaps that create the screen door effect) or otherwise give the impression that there is more pixel resolution than there actually is (to increase the perceived resolution of the display). Such pixel shifting techniques are described herein as fractional pixel shifting techniques since the pixel array in these examples shifts by partial pixels in order to create new and different pixel positions in the display.

While fractional pixel shifting techniques may be useful for achieving their intended objectives and may be employed in certain implementations described herein (as further detailed below), fractional pixel shifting is fundamentally distinct in function and objective from non-fractional pixel shifting described herein. As described above and as will be further detailed below, non-fractional pixel shifting involves shifting pixels to the same pixels positions that have already been used (i.e., shifting by whole pixel distances) with an objective not of increasing perceived resolution, but, rather, of mitigating underperforming pixels so as to improve yield, performance uniformity, and the overall performance level with respect to criteria of interest (e.g., brightness, color, efficiency, etc., rather than resolution or spatial continuity). Accordingly, while some implementations may employ both fractional and non-fractional pixel shifting as technical solutions to these distinct technical problems, the difference between these techniques and the objectives they serve should be appreciated.

Technical effects of the technical solutions described herein may include achieving various objectives described above, as well as additional benefits as will be made apparent. Specifically, for example, non-fractional pixel shifting may mitigate pixel performance disparities with the technical effect of a display or image uniformity (the pixels as viewed in the display and as perceived by the user) that is significantly improved over the panel uniformity (the physical pixels as operated on the pixel panel before their light is transported to the display). This improved uniformity may also result, as has been mentioned, in technical effects such as improved performance (e.g., brighter or more efficient displays, displays with more accurate and uniform color reproduction, etc.), improved yield (e.g., fewer pixel panels that fail to satisfy performance thresholds as a tolerance for underperforming pixels is increased), reduced costs, and so forth.

Various implementations will now be described in more detail with reference to the figures. It will be understood that particular implementations described below are provided as non-limiting examples and may be applied in various situations. Additionally, it will be understood that other implementations not explicitly described herein may also fall within the scope of the claims set forth below. Systems and methods described herein for non-fractional pixel shifting to improve pixel performance may result in any or all of the technical effects mentioned above, as well as various additional effects and benefits that will be described and/or made apparent below.

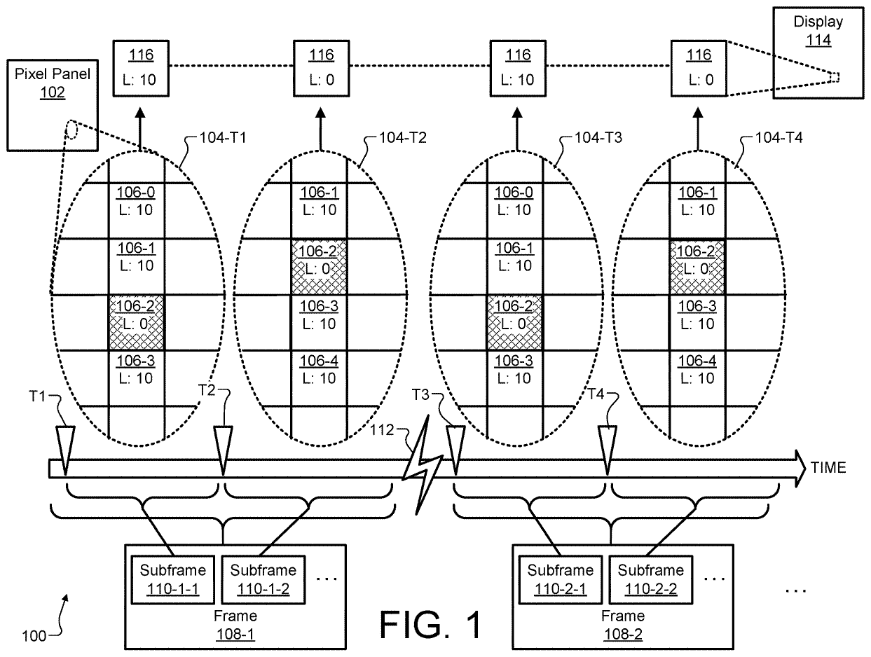

FIG. 1 shows aspects of one illustrative implementation 100 of non-fractional pixel shifting to improve pixel performance of a display in accordance with principles described herein. As shown, implementation 100 includes a pixel panel 102 that will be understood to include an array of pixels disposed in a two-dimensional grid (e.g., a standard rectilinear grid or another suitable pattern repeating pattern that may be non-rectilinear). Several expansions 104-T1 through 104-T4 of certain pixels 106-0 through 106-4 of pixel panel 102 are expanded (i.e., zoomed into for illustrative purposes) in FIG. 1 along a timeline (“Time”). More particularly, as shown, the timeline is labeled with several distinct moments in time labeled T1, T2, T3, and T4, and the expansions of pixel panel 102 show how pixels 106-0 through 106-4 may be shifted at these different times (e.g., expansion 104-T1 representing the pixels starting at time T1, expansion 104-T2 representing the pixels starting at time T2, expansion 104-T3 representing the pixels starting at time T3, and expansion 104-T4 representing the pixels starting at time T4).

Pixel panel 102 may represent a pixel panel with pixels of one particular color (e.g., red, green, blue, etc.) or a multi-color pixel panel that includes multi-colored pixels (e.g., red, green, and blue pixels for an RGB color scheme) that are configured to reproduce many colors. Accordingly, each pixel 106-0 through 106-4 shown in this example will be understood to represent a single pixel of a given color (e.g., a red LED, a green LED, etc.) or a single multi-color pixel (e.g., combination of a red, a green, and a blue LED, etc.). While microLED pixel technologies are used as a primary example herein, it will be understood that principles described herein may apply identically or at least analogously to various other suitable pixel technologies that may be used in various implementations.

Implementation 100 shows the presentation of two frames 108-1 and 108-2 of a frame sequence that will be understood to include any suitable number of frames (e.g., a video frame sequence with thousands of frames being presented for a fraction of a second each). As shown, each of frames 108-1 and 108-2 include a plurality of subframes, two of which are illustrated for each frame (though ellipses following each pair of subframes indicate that several other subframes could be included in each frame as may serve a particular implementation). Specifically, as shown, frame 108-1 includes a subframe 110-1-1 that is displayed starting at time T1 and a subframe 110-1-2 that is displayed starting at time T2. Since other subframes may be included as part of the presentation of frame 108-1, a break 112 in the timeline is shown prior to time T3 when presentation of frame 108-2 begins. As shown after break 112, frame 108-2 includes a subframe 110-2-1 that is displayed starting at time T3 and a subframe 110-2-2 that is displayed starting at time T4 (after which other subframes and frames will be understood to follow as time continues on).

In the present disclosure, a frame may be associated with a frame time during which the frame is presented on the display. For example, frames 108-1 and 108-2 are shown to each be presented during a frame time indicated by respective brackets on the timeline in FIG. 1. Then, as shown by the brackets associated with subframes 110 in FIG. 1, a first subframe of the frame may be presented on the display for a first portion of the frame time and a second subframe of the frame may be presented on the display for a second portion of the frame time. In particular, the second portion of the frame time may be a later portion of the frame time than the first portion of the frame time. The first and second portions may add up to the frame time. It will be understood that a frame may comprise more than two subframes. If a frame comprises three subframes, for instance, its third subframe would be presented on the display for a third portion of the frame time and the third portion of the frame time may be a later portion of the frame time than the second portion of the frame time. In this case, the first, second and third portions may add up to the frame time.

As shown in each expansion 104 (i.e., expansions 104-T1 through 104-T4), pixels 106 of pixel panel 102 (i.e., pixels 106-0 through 106-4 and other pixels not explicitly shown or labeled) may shift up and down for time periods associated with each subframe. Specifically, as shown, the pixels may be disposed in one location at time T1 for the presentation of subframe 110-1-1 (i.e., so that expansion 104-T1 shows pixels 106-0 through 106-3), then may shift up one pixel at time T2 for the presentation of subframe 110-1-2 (i.e., so that expansion 104-T2 shows pixels 106-1 through 106-4). Likewise, when frame 108-2 begins, the pixels may again be disposed in the first location at time T3 for the presentation of subframe 110-2-1 (i.e., so that expansion 104-T3 again shows pixels 106-0 through 106-3), then may again shift up one pixel at time T4 for the presentation of subframe 110-2-2 (i.e., so that expansion 104-T4 again shows pixels 106-1 through 106-4). While this example shows just two positions of a one-dimensional (i.e., 1-axis) pixel shifting pattern, it will be understood (and described in more detail below) that more complex patterns with shifting along multiple dimensions to multiple positions may be used as may serve a particular implementation.

Along with pixel panel 102 and its various pixels 106, implementation 100 further shows a display 114 where a user (not shown in FIG. 1) may view light emitted by pixel panel 102. For example, as will be described in more detail below, display 114 may represent the display screen or projection where light is presented after being emitted by pixel panel 102 and transported by an optical assembly of lenses, waveguides, and the like. Display 114 may present light from the various pixels at static locations within the display referred to herein as pixel positions. For example, one example pixel position 116 is shown to be expanded from display 114 and is depicted above each expansion 104 along the timeline. As a result of non-fractional pixel shifting described herein, a given pixel position such as pixel position 116 may host (be associated with) different pixels from the pixel panel at different times. In this example implementation, for instance, pixel position 116 may host pixel 106-1 after time T1 (i.e., during presentation of subframe 110-1-1) and may host pixel 106-2 after time T1 (i.e., during presentation of subframe 110-1-2). Similarly for frame 108-2, pixel position 116 may again host pixel 106-1 starting after time T3 (i.e., during presentation of subframe 110-2-1) and host pixel 106-2 starting after time T4 (i.e., during presentation of subframe 110-2-2).

By non-fractionally shifting the pixels 106 of pixel panel 102 in this way, implementation 100 shows how underperformance of a pixel may be mitigated. As shown, each pixel 106 may perform at a performance Level labeled ‘L’. For simplicity, it will be assumed that the target performance for each pixel is 10 units of some criterion (described in more detail below) and that pixels 106-0, 106-1, 106-3, and 106-4 are each functional pixels capable of performing at this target level. Therefore, as shown, each of these pixels 106-0, 106-1, 106-3, and 106-4 is indicated to be performing at “L: 10.” In this example, however, pixel 106-2 will be assumed to be a dead (i.e., completely non-operational) pixel. Shading of pixel 106-2 represents that the underperforming pixel may be dark or otherwise may stand out as compared to the functional pixels around it.

Without pixel shifting, each pixel position of display 114 would statically host a particular pixel from pixel panel 102 and, as such, a dead pixel such as pixel 106-2 may result in an undesirable dark spot when a user views display 114. The non-fractional pixel shifting illustrated in FIG. 1, on the other hand, mitigates that issue by associating each pixel position of display 114 with multiple pixels (at least one of which is likely to be a functional pixel). For example, this is illustrated by pixel position 116, which will be understood to be associated with a pixel grouping including pixels 106-1 and 106-2. While pixel position 116 may exhibit a performance level L: 0 when hosting pixel 106-2 during the presentation of subframes 110-1-2 and 110-2-2, pixel position 116 is also shown to exhibit a performance level L: 10 when hosting pixel 106-1 during the presentation of subframes 110-1-1 and 110-2-1. In other words, as shown, rather than being dead (L: 0) all the time, pixel position 116 is shown to rapidly toggle between L: 0 and L: 10 for each frame. A user viewing display 114 may perceive this as approximately an average performance between L: 0 and L: 10. For instance, the user may perceive pixel position to perform at approximately level L: 5 in this example.

The various subframes 110 (subframes 110-1-1 through 110-2-2 and other subframes not explicitly shown) in the various frames 108 (frames 108-1, 108-2, and other frames not explicitly shown) may include any suitable content as may serve a particular implementation. However, whereas subframes used for fractional pixel shifting schemes may be configured to be distinct for pixels that are to be displayed at different pixel positions (to thereby give the illusion of additional pixel resolution), subframes 110 used for a non-fractional pixel shifting scheme such as illustrated by implementation 100 will be understood to be associated with the same or very similar content (albeit shifted) from subframe to subframe. For example, for the pixel shift up from expansion 104-T1 to expansion 104-T2, the same color and/or intensity may be driven to pixel 106-0 (in the top slot of the expansion) at time T1 as is driven to pixel 106-1 at time T2. Likewise, the same content may be driven to pixel 106-1 at time T1 and to pixel 106-2 at time T2 (even though pixel 106-2 may be unable to present the content due to its defectiveness), to pixel 106-2 at time T1 (even though the content cannot be presented by the defective pixel) and to pixel 106-3 at time T2, to pixel 106-3 at time T1 and to pixel 106-4 at time T2, and so forth.

While generic units between 0 and 20 are arbitrarily used in examples throughout this description (e.g., where the L: 0 and L: 10 performance levels described above are two such examples), it will be understood that the criteria with respect to which performance is assessed may include any suitable criteria (e.g., figures of merit, characteristics or attributes of interest, etc.) measured using any suitable units as may serve a particular implementation.

As a first example, one criterion with respect to which various aspects of performance (e.g., an actual performance level, a target performance level, a performance capability, and/or other aspects of performance) may be defined is pixel brightness. For example, if pixel brightness is a performance criterion of interest, a performance capability of a particular pixel may define how brightly the particular pixel is capable of performing (i.e., how much luminance the pixel is capable of producing with light it emits). Pixel brightness may refer to the inherent ability of a pixel to emit light, or, in other words, may constitute a measure of how much light a pixel can produce. Pixel brightness may be measured in units such as nits, candelas per meter squared (cd/m²), or other suitable units.

As a second example, another criterion with respect to which the various aspects of performance may be defined is pixel chromaticity. For example, if pixel chromaticity is a performance criterion of interest, a performance capability of a particular pixel may define how close to a nominal color the particular pixel is capable of achieving (i.e., how close a frequency of light emitted by the pixel is to a nominal frequency that it is desired for the light being produced). Just as brightness uniformity may be improved by non-fractional pixel shifting described herein when the criterion is pixel brightness, wavelength uniformity may similarly be improved for a pixel chromaticity criterion. For example, two neighboring pixels could have a color difference even when displaying nominally the same color. This difference may be expressed in units of Du′v′ (e.g., with a value of at least 0.01, 0.001, 0.001, 0.0001, etc.), in units of DE2000 (e.g., with a value of at least 1000, 300, 100, 30, 10, 3, 1, etc.), or in other color difference units. The two corresponding pixels as presented on display 114 (e.g., within pixel position 116 or another pixel position) may similarly have a color difference that, when put into a ratio with the color difference of the pixels, may show improved uniformity between the pixels. For example, rather than a ratio of 1:1, the ratio could be 1:10, 1:20, 1:100, 1:200, 1:1000, or the like).

As a third example, another criterion with respect to which the various aspects of performance may be defined is pixel efficiency. For example, if pixel efficiency is a performance criterion of interest, a performance capability of a particular pixel may define how efficiently the particular pixel is capable of performing (i.e., how effectively the pixel utilizes the energy it receives to generate light). Pixel efficiency may be expressed as a ratio between the amount of light a pixel emits and the amount of energy the pixel consumes. As such, a higher pixel efficiency would imply that a pixel is capable of producing more light for the same amount of energy, leading to a more energy-efficient display.

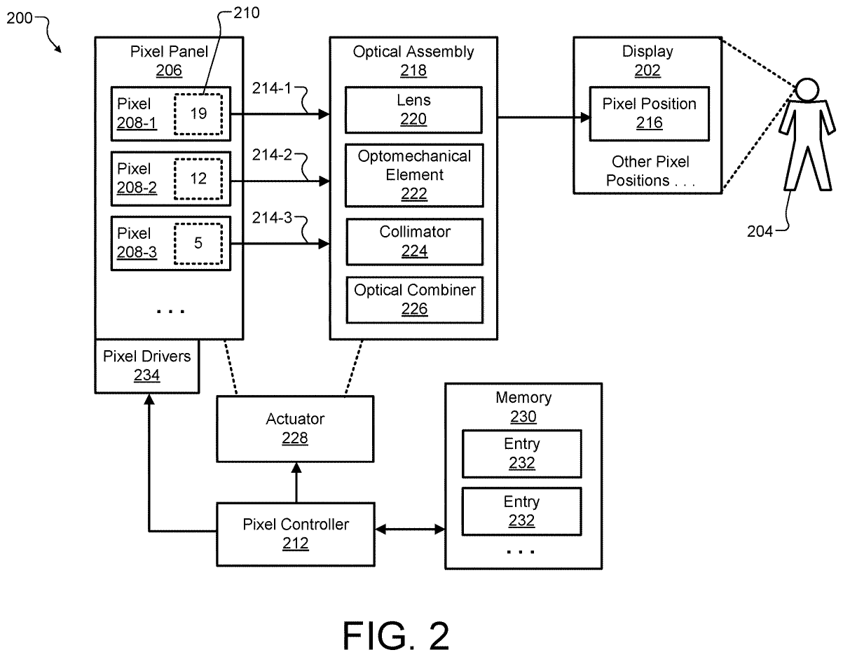

FIG. 2 shows an illustrative display system 200 configured to perform non-fractional pixel shifting to improve pixel performance in accordance with principles described herein. For example, principles described above in relation to implementation 100 may be understood to be implemented using a particular implementation of display system 200.

As shown, display system 200 may include a display 202 for presentation to a user 204 and a pixel panel 206 that includes various pixels 208 (e.g., a first pixel 208-1, a second pixel 208-2, a third pixel 208-3, and other pixels 208 not explicitly shown but represented by ellipsis). Each of the pixels 208 of pixel panel 206 may be associated with a particular performance capability 210 with respect to a criterion such as the example performance criteria described above. As shown in this example, for instance, pixel 208-1 may have a first performance capability of 19 units with respect to the criterion, pixel 208-2 may have a second performance capability of 12 units with respect to the criterion, and pixel 208-3 may have a third performance capability of 5 units with respect to the criterion. As described above, the criterion and units in this example are shown as generic quantitative values between 0 and 20 units for illustrative purposes. These values will be understood to represent one or more actual performance parameters (e.g., brightness parameters, efficiency parameters, color parameters, etc.) using suitable units such as those mentioned in relation to the performance criteria described above.

Along with display 202 and pixel panel 206, display system 200 is further shown to include a pixel controller 212 that may be configured to cause display system 200 to present a frame (e.g., one of frames 108 illustrated in FIG. 1) on display 202 by directing other system components. For example, pixel controller 212 may direct display system 200 to perform operations including at least: 1) causing first light 214-1 emitted by pixel 208-1 to be displayed at a pixel position 216 on display 202 during presentation of a first subframe of the frame; and 2) causing second light 214-2 emitted by pixel 208-2 to be displayed at the same pixel position 216 on display 202 during presentation of a second subframe of the frame. While the simplest non-fractional pixel shifting example may include a pixel grouping of just two pixels (e.g., pixels 208-1 and 208-2) that are alternately displayed at pixel position 216, it will be understood (and described and illustrated in more detail below) that certain pixel shifting patterns may involve more than two pixels in a pixel grouping associated with a particular pixel position such as pixel position 216. For instance, in this example of FIG. 2 third pixel 208-3 (and possibly one or more additional pixels 208 not explicitly shown) may emit light (e.g., third light 214-3 emitted by pixel 208-3) that pixel controller 212 causes to be displayed at pixel position 216 on display 202 during presentation of additional subframes of the frame (e.g., a third subframe for the example of third light 214-3).

FIG. 2 shows various example components that display system 200 may include to allow pixel controller 212 to perform these non-fractional pixel shifting operations. Specifically, light 214-1, 214-2, and 214-3 may be directed to the same pixel position 216 for different subframes by operations performed by pixel controller 212 with assistance from: 1) an optical assembly 218 that includes a lens 220, an optomechanical element 222, a collimator 224, and an optical combiner 226; 2) an actuator 228 that is coupled to either or both of pixel panel 206 and optical assembly 218 (e.g., to optomechanical element 222 in particular); 3) a memory 230 that includes a plurality of entries 232; 4) a set of pixel drivers 234 corresponding to the various pixels 208; and/or any other suitable system components as may serve a particular implementation. Each of these elements will now be described in more detail.

Optical assembly 218 may be configured to transport light from pixel panel 206 (e.g., first light 214-1, second light 214-2, third light 214-3, etc.) from the respective pixels emitting the light to particular pixel positions on display 202. To this end, as shown, optical assembly 218 may include any of a variety of optical elements such as one or more lenses (e.g., the lens 220) for focusing the light, the optomechanical element 222 (e.g., a mirror, an optical plate, etc.) for redirecting the light to effect pixel shifting for certain types of embodiments (described in more detail below), the collimator 224 for collecting and aligning the light from pixels 208 to form an intermediate image (e.g., in angular space), and the optical combiner 226 for combining light from the pixel panel and, in some examples, ambient light (e.g., light passing through a transparent display). One or more waveguides (e.g., diffractive waveguides, reflective waveguides, etc.), gratings, or other optical elements may be used to implement one or more of the components of optical assembly 218, such as optical combiner 226. For example, after light is processed and steered by lens 220 and optomechanical element 222 and the intermediate image is produced by collimator 224, a waveguide implementing optical combiner 226 may output a display image to display 202 for viewing by user 204.

Actuator 228 may be implemented by a voice coil, a piezo, or another suitable pixel shifting actuator mechanism. Pixel controller 212 may control actuator 228 to cause the non-fractional pixel shifting described above to occur in various ways. As a first example, actuator 228 may be configured to displace optomechanical element 222. For instance, optomechanical element 222 may be implemented by an optical plate (e.g., constructed from glass or another suitable material) that is coupled with actuator 228 in a manner that allows pixel controller 212 to direct actuator 228 to displace the optical plate such that light emitted by pixel panel 206 is shifted with respect to display 202. For example, the displacement of the optical plate at different angles may direct light passing through the plate to slightly shift as actuator 228 displaces optomechanical element 222. In some examples, actuator 228 may oscillate optomechanical element 222 in a suitable pixel shifting pattern (e.g., a square wave pattern, a sinusoidal pattern, etc.) to effect the desired non-fractional pixel shifting (e.g., in accordance with any of the pixel shifting patterns described herein).

As a second example, actuator 228 may be configured to displace pixel panel 206 itself (such that, in this case, no optomechanical element 222 may be utilized within optical assembly 218). For example, pixel panel 206 may be coupled to actuator 228 in such a way that pixel controller 212 causes light from different pixels 208 to be displayed at the same pixel position by directing actuator 228 to displace pixel panel 206 such that pixel panel 206 is shifted with respect to optical assembly 218 and display 202. Here again, actuator 228 may be implemented by a voice coil, piezo, or other suitable actuating mechanism capable of shifting pixel panel 206 by one or more non-fractional pixel amounts in accordance with a desired pixel shifting pattern (e.g., one of the patterns described herein).

In some examples (one of which was illustrated above with implementation 100), non-fractional pixel shifting may be performed without regard for or without accounting for particular performance capabilities of individual pixels 208. For example, an implementation may be constructed with an assumption that underperforming pixels are distributed randomly throughout a pixel panel and are rare enough as to generally be surrounded by functional pixels. As long as these assumptions generally hold true, significant uniformity gains may be achieved without regard for how specific pixels actually perform. For instance, in the example of implementation 100 described above, the dead pixel performing at level L: 0 happened to be surrounded by functional pixels performing at level L: 10, such that the illustrated two-position pixel shifting resulted in pixel position 116 exhibiting an average performance of 5 units rather than 0 units.

Such improvements may be sufficient to gain many of the benefits and technical effects described herein, and advantageously do not require the overhead of tracking particular performance capabilities of each pixel and the pixels around it that may share a pixel position in the display. For certain implementations, however, such overhead may be a small price to pay for further performance improvements that may be gained by carefully tracking and accounting for performance capabilities of pixels in groupings that share a given pixel position. In these types of implementations, pixel underperformance may not only be partially mitigated but, in many cases, may be completely remedied, as will be described and illustrated in more detail below.

For these types of implementations, display system 200 is shown to include memory 230 which may include (among other things) software instructions for pixel controller 212 (not shown), image content that pixel controller 212 is to cause to be displayed (e.g., data representing the various frames and subframes, etc., also not shown), and, optionally, a plurality of entries 232 configured to indicate measured performance capabilities of pixel panel 206. For example, each entry 232 may be associated with a particular pixel position (e.g., pixel position 216) and a pixel grouping of two or more pixels 208 that share that pixel position in the non-fractional pixel shifting scheme. One entry 232, for instance, may be included for a pixel grouping that includes pixel 208-1, 208-2, and 208-3 (as well as any other pixels 208 that may be shifted into pixel position 216). This entry may indicate the first performance capability of pixel 208-1 (i.e., 19 units in this example), the second performance capability of pixel 208-2 (i.e., 12 units in this example), the third performance capability of pixel 208-3 (i.e., 5 units in this example), and so forth.

The light 214-1 emitted by pixel 208-1, the light 214-2 emitted by pixel 208-2, the light 214-3 emitted by pixel 208-3, and other light associated with the pixel grouping may then be based on the entry. For example, pixel controller 212 may direct pixel drivers 234 corresponding to these pixels to drive them in a manner that accounts for not only a given pixel's performance capability but also its neighbors with whom it shares a pixel position. In this example, for instance, pixel controller 212 may, based on the entry 232 associated with this pixel grouping of pixel position 216, cause pixel drivers 234 to overdrive pixel 208-1 (given that it has plenty of performance capability) to help compensate for the low performance capability of pixel 208-3. If the target performance for pixel position 216 was 10 units for a particular frame, for example, the relevant entry 232 may cause pixel controller 212 to overdrive pixel 208-1 at 15 units to compensate for the fact that pixel 208-3 is only capable of 5 units. In this way, light 214-1 and 214-3 may average the desired performance of 10 units and the deficiency of pixel 208-3 would be fully remedied.

More generally, FIG. 2 shows an example where a pixel grouping associated with pixel position 216 includes at least three pixels 208-1, 208-2, and 208-3, with different respective performance capabilities with respect to a particular performance criterion. In this case, the performance capability of pixel 208-1 may be more than sufficient to achieve a target performance at pixel position 216. For instance, if the target performance is 10 units, the performance capability of 19 units exhibited by pixel 208-1 is more than sufficient to achieve this target. The performance capability of pixel 208-2 may then be at least sufficient to achieve the target performance at pixel position 216 (i.e., 12 units is not much more than the targeted 10 units, but it is at least sufficient), and the performance capability of pixel 208-3 may be less than sufficient to achieve the target performance at pixel position 216 (i.e., 5 units of capability is not sufficient to achieve the 10 unit target). Based on an entry 232 that incorporates this information, pixel controller 212 may therefore cause light 214-1 to be above the target performance (e.g., 15 units in this example), light 214-2 to be at the target performance (e.g., 10 units in this example), and light 214-3 to be below the target performance (e.g., 5 units in this example, since that is the maximum performance of which pixel 208-3 is capable).

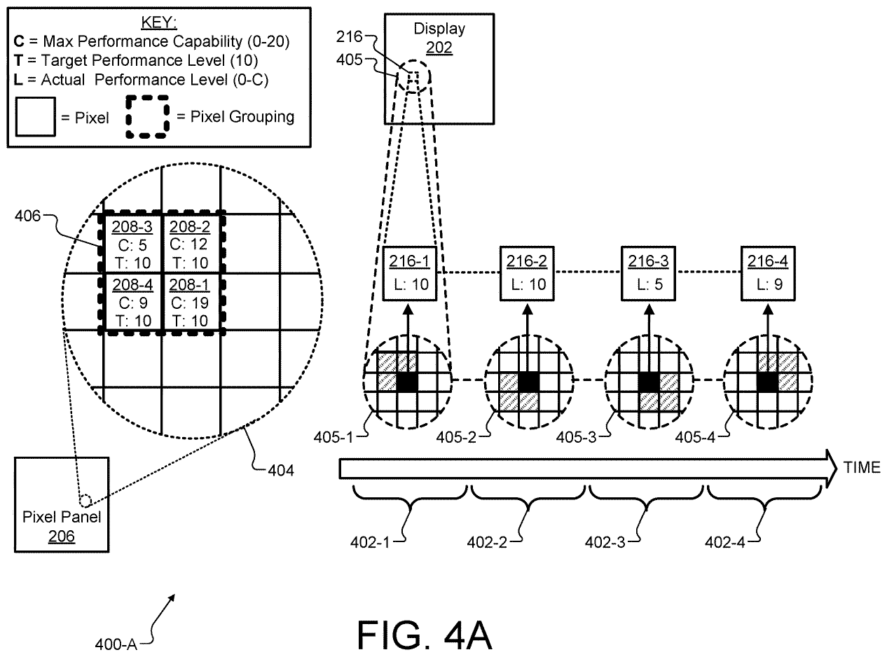

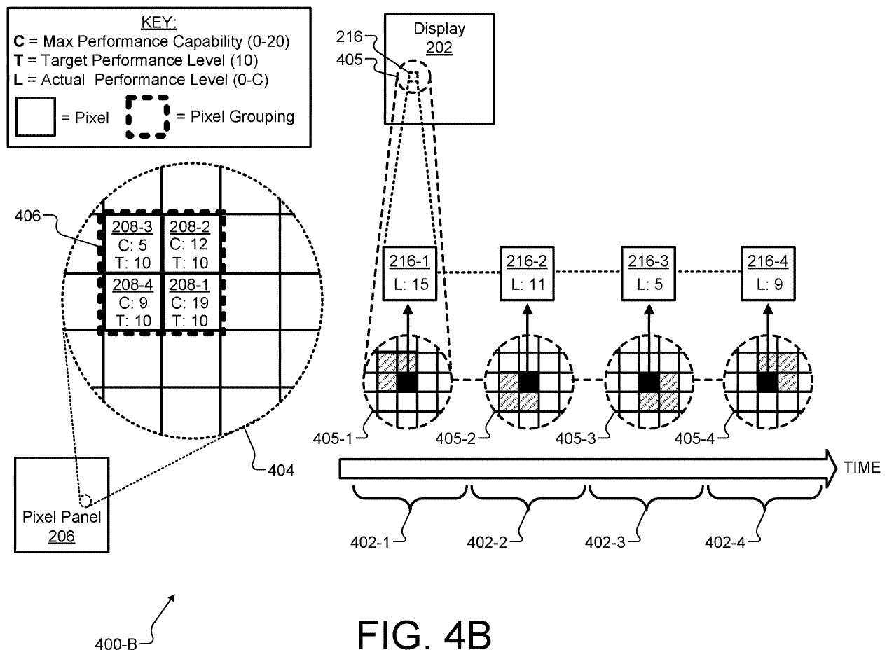

Entries 232 stored in memory 230 may form a mapping of pixel performance (e.g., a demura table, etc.) that may be used in the ways described above to improve the display system performance beyond the improvements achieved by implementations that do not account for specific discrepancies in this way. Entries 232 may be determined in any suitable way, such as by way of system characterization during the manufacturing process or during a calibration or setup stage of the system. For example, each pixel 208 may be driven in a particular way so that its performance with respect to criteria of interest may be measured, assessed, and properly stored in the table (e.g., within various entries of which it may be a part). Examples will be illustrated below of both an implementation that does not account for specific performance capabilities to avoid the overhead of generating and tracking pixel performance entries 232 (see FIG. 4A), as well as an implementation that does account for specific performance capabilities to more effectively mitigate pixel performance disparities (see FIG. 4B).

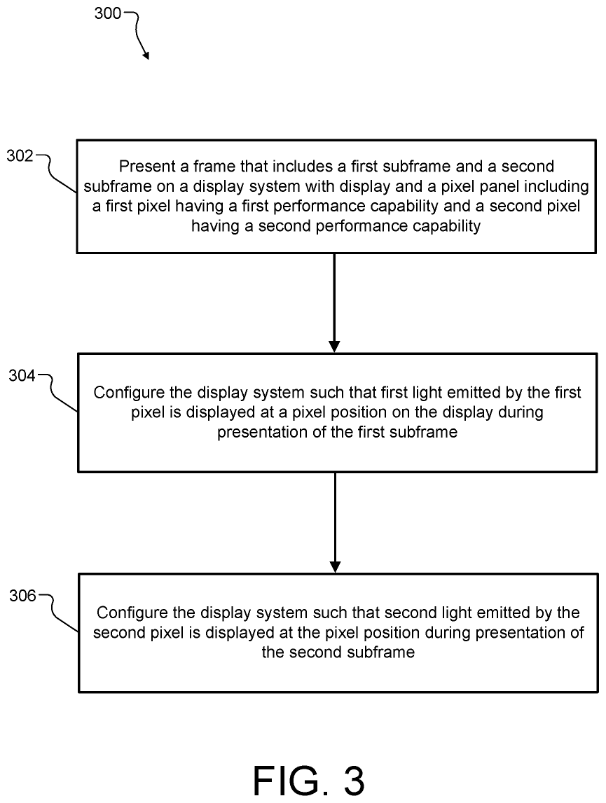

FIG. 3 shows an illustrative method 300 with operations 302 through 306 for non-fractional pixel shifting to improve pixel performance in accordance with principles described herein. Method 300 shows an example sequence of operations that may be performed by display system 200 to implement non-fractional pixel shifting to mitigate pixel performance disparities in ways described herein. While FIG. 3 shows illustrative operations according to a certain implementation, however, it will be understood that other implementations may omit, add to, reorder, and/or modify any of the operations shown in method 300. In some examples, multiple operations shown or described in relation to method 300 may be performed concurrently (e.g., in parallel) with one another, rather than being performed sequentially as illustrated and/or described. Each of operations 302 through 306 will now be described in more detail as the operations may be performed by an implementation of display system 200 that includes a display and a pixel panel with at least a first pixel having a first performance capability with respect to a criterion and a second pixel having a second performance capability with respect to the criterion.

At operation 302, the display of the display system may present a frame that includes at least a first subframe and a second subframe. In some implementations that do not account for specific performance capabilities (described above and illustrated below in FIG. 4A), the first subframe and the second subframe may be identical (or nearly identical) other than shifting data to account for the shift in pixels that may be performed between the presentation of the two subframes. For instance, if the pixels of the pixel panel are to be shifted up one pixel (e.g., by way of the panel itself being displaced, by way of an optomechanical element steering the light to be slightly higher on the display, or in another suitable way) from the first to the second subframe, the second subframe may be identical to the first subframe other than being shifted down by a pixel (i.e., to ensure that the content displayed at each pixel position of the display remains consistent throughout the frame).

In other implementations that do account for specific performance capabilities (described above and illustrated below in FIG. 4B), the first and second subframes may be similar to one another with the same objective of displaying consistent-looking content through the frame. However, based on the performance disparities represented in a mapping or other table described above (e.g., a demura table with entries 232, etc.), the second subframe may alter certain pixels to, for example, overdrive functional pixels with more than sufficient performance capabilities in a manner that helps further compensate for underperforming pixels. For example, referring to pixels 208 illustrated above, the second subframe may cause pixel 208-1 to produce brighter light 214-1 at pixel position 216 to compensate for the dimmer light 214-3 of pixel 208-3.

At operation 304, the display system may be configured such that first light emitted by the first pixel is displayed at a particular pixel position on the display during presentation of the first subframe. In some cases, this configuring of the display system at operation 304 may be directed by a pixel controller included in the display system (e.g., pixel controller 212) to be accomplished in any of the ways described herein. For example, the pixel controller may direct an actuator to shift an optomechanical element to steer the first light to the particular pixel position, may direct an actuator to shift the pixel panel to steer the first light to the particular pixel position, or may perform a combination of these or another suitable technique.

At operation 306, the display system may be configured such that second light emitted by the second pixel is displayed at the particular pixel position on the display during presentation of the second subframe. As with the configuring at operation 304, this configuring of the display system at operation 306 may be directed by the pixel controller to be accomplished in any of the ways described herein. For example, the pixel controller may direct an actuator to shift an optomechanical element to steer the second light to the particular pixel position, may direct an actuator to shift the pixel panel to steer the second light to the particular pixel position, or may perform a combination of these or another suitable technique.

As mentioned above, FIGS. 4A and 4B show aspects of different illustrative implementations of non-fractional pixel shifting during presentation of a frame that includes a plurality of subframes. In particular, FIG. 4A shows an implementation 400-A that does not specifically or intentionally attempt to account for a mapping of pixel performance capabilities (though it will be understood that the pixels still have performance capability discrepancies that are inherently mitigated to some degree by the pixel shifting). FIG. 4B, in contrast, shows an implementation 400-B that does specifically account for differences in pixel performance capabilities, such as by use of a mapping (e.g., a demura table, etc.) described in relation to entries 232 of memory 230 above.

Both implementations 400-A and 400-B show a timeline (the arrow labeled “TIME”) along which distinct subframe times 402 (i.e., times 402-1, 402-2, 402-3, and 402-4) are shown. Each of these subframe times 402 will be understood to represent a range of time (a portion of a total frame time range) in which a different subframe of a single frame is presented. As shown, the frame in this example includes four subframes that are presented in sequence at subframe times 402-1, 402-2, 402-3, and 402-4, after which presentation of a new frame (also composed of four subframes) may begin.

An expansion 404 of several pixels of pixel panel 206 is shown on the left side of the figures, and similar respective expansions 405 (i.e., expansions 405-1, 405-2, 405-3, and 405-4) are depicted above each subframe time 402 to illustrate how pixels of interest in pixel panel 206 may shift with respect to display 202 as each of the four subframes is presented.

More particularly, the expansion 404 labels a pixel grouping 406 by outlining four pixels with a thick dotted line and labeling these as pixels 208-1, 208-2, 208-3, and 208-4. As indicated by the KEY above expansion 404, each of these pixels 208 in pixel grouping 406 is associated with a maximum performance capability indicated with the letter ‘C.’ For illustrative purposes, the performance capability values in this example are arbitrarily quantified with a value between 0 and 20 units to represent the particular performance capability for each pixel with respect to a particular criterion such as the example performance criteria that have been described. For this example, FIGS. 4A and 4B show that pixel 208-1 may be a very high-performing pixel with a performance capability of 19 units, pixel 208-2 may be a functional (though not quite so high-performing) pixel with a performance capability of 12 units, pixel 208-3 may be an underperforming pixel with a performance capability of only 5 units, and pixel 208-4 may be an underperforming pixel with a performance capability of 9 units.

Each of pixels 208 in pixel grouping 406 is further shown to be associated with a target performance level indicated with the letter ‘T’. For illustrative purposes, each of the pixels 208 is shown to have a same target value of 10 units in this example, though it will be understood that the target performance may be different for various pixels in accordance with the image content of different frames. For descriptive purposes, the target value of 10 units is assumed in this example to also serve as the threshold between what is considered a functional pixel and an underperforming pixel. That is, pixels with performance capabilities of 10 and greater (e.g., pixels 208-1 and 208-2) are considered to be functional in this example while pixels with performance capabilities less than 10 are considered to be underperforming. Additionally, the target performance level of each pixel will be understood to represent the desired performance of that pixel for the present frame. For example, if the criterion is brightness, the particular frame represented in FIGS. 4A and 4B may call for all pixels 208 to be displayed with 10 units of brightness.

The four pixels 208-1 through 208-4 are also represented in each of expansions 405. Though not individually labeled, the grouping of four shaded pixels in these miniaturized expansions will be understood to represent pixel grouping 406 and the four pixels 208 included therein. As shown, pixel grouping 406 shifts from subframe to subframe (i.e., to be different during each subframe time 402) such that a different pixel (shaded in full black in each expansion 405) is hosted by pixel position 216 of display 202 for each subframe. Specifically, as shown, the pixel grouping 406 of pixels 208 begins in a first position that aligns pixel 208-1 with pixel position 216, then the pixels shift down one pixel to align pixel 208-2 with pixel position 216 for time 402-2, shift right one pixel to align pixel 208-3 with pixel position 216 for time 402-3, and shift up one pixel to align pixel 208-4 with pixel position 216 for time 402-4. While not shown, it will be understood that the pixel grouping 406 may thereafter shift left one pixel to return to the original position (with pixel 208-1 aligned with pixel position 216) after subframe time 402-4 for the next frame.

Above each expansion 405, indications of the actual performance level achieved at pixel position 216 are depicted by the letter ‘L’ in a box labeled 216-x (where ‘x’ indicates the relevant subframe). More particularly, pixel position 216-1 represents the performance level achieved at pixel position 216 during time 402-1, pixel position 216-2 represents the performance level achieved at pixel position 216 during time 402-2, pixel position 216-3 represents the performance level achieved at pixel position 216 during time 402-3, and pixel position 216-4 represents the performance level achieved at pixel position 216 during time 402-4.

As has been stated, the difference between FIGS. 4A and 4B relates to whether or not the pixel controller accounts for performance capabilities of pixels in the same pixel grouping as pixels are driven during the various subframes. FIG. 4A represents an implementation in which such information is not accounted for. Accordingly, as shown, since the target performance level is 10 units, each of the pixels 208 in the pixel panel 206 is driven to an actual performance of 10 units and each pixel either performs at that level (if it is functional and capable of doing so) or as close to that level as it is capable (if it is an underperforming pixel incapable of hitting the target). This is illustrated by pixel position 216-1 exhibiting an actual performance level L: 10 (since pixel 208-1 is capable of achieving the target performance level), pixel position 216-2 exhibiting an actual performance level L: 10 (since pixel 208-2 is also capable of achieving the target performance level), pixel position 216-3 exhibiting an actual performance level L: 5 (since pixel 208-3 is underperforming and C: 5 is its maximum performance capability), and pixel position 216-4 exhibiting an actual performance level L: 9 (since pixel 208-4 is underperforming and C: 9 is its maximum performance capability).

The average performance level that may be perceived by a user at pixel position 216 during the frame time may be an average of the actual performance levels exhibited during the four subframe times 402. That is, rather than presenting a performance level of 10 units, as targeted, pixel position 216 may be perceived as presenting a performance level of (10+10+5+9)/4=8.5 units. While this performance is not quite the 10 units that may be desirable, it is considerably better than the 5 units that a pixel position corresponding to underperforming pixel 208-3 would have if no non-fractional pixel shifting were implemented. Moreover, even though the underperforming pixels slightly pull the functional pixels down in this example (just as the functional pixels pull the underperforming pixels up), the uniformity of display 202 may be significantly improved, which, at least for certain applications, could be just as beneficial and desirable as improving the raw performance. In other words, while abstaining from pixel shifting may result in a highly non-uniform patchwork of high and low performing pixels, non-fractional pixel shifting in accordance with FIG. 4A may result in a much more uniform display in which the maximum performance disparity perceived between pixel positions (and particularly between neighboring pixel positions) is minimized.

FIG. 4B then illustrates another type of implementation in which the performance capabilities of each pixel in a given pixel grouping is explicitly measured and accounted for such that both the uniformity and the overall performance may be significantly improved (at a cost, compared to FIG. 4A, of additional memory, processing, and/or complexity introduced by this accounting). Specifically, as shown in FIG. 4B, since the target performance level is 10 units and the capabilities of functional pixels 208-1 and 208-2 have some extra performance headroom above this target, the functional pixels may be intentionally driven above the target level to help compensate for the underperforming pixels that are incapable of achieve the target level. This is illustrated in FIG. 4B by pixel position 216-1 exhibiting an actual performance level L: 15 (since pixel 208-1 is capable of being overdriven in this way and the controller assesses that this overdriving can help compensate for other underperforming pixels in the pixel grouping), pixel position 216-2 exhibiting an actual performance level L: 11 (for the same reasons), pixel position 216-3 exhibiting an actual performance level L: 5 (since pixel 208-3 is underperforming and C: 5 is its maximum performance capability), and pixel position 216-4 exhibiting an actual performance level L: 9(since pixel 208-4 is underperforming and C: 9 is its maximum performance capability).

As in implementation 400-A, the average performance level for implementation 400-B that may be perceived by a user at pixel position 216 during the frame time may be an average of the actual performance levels exhibited during the four subframe times 402. In this example, however, the overdriving of the functional pixels to compensate for the underperformers allows the target level to be achieved, at least as the user will perceive the performance at pixel position 216. That is, pixel position 216 may be perceived as presenting a performance level of (15+11+5+9)/4=10 units. Accordingly, in this case, the underperformance of pixels 208-3 and 208-4 is fully compensated for by the extra performance headroom possessed by the functional pixels 208-1 and 208-2, as well as the pixel-grouping-aware processing that accounts for these performance differences.

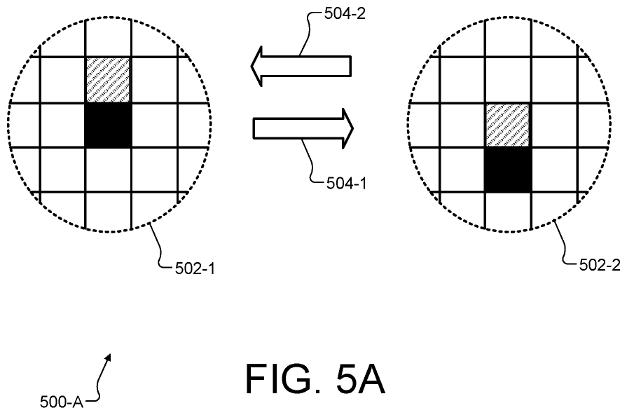

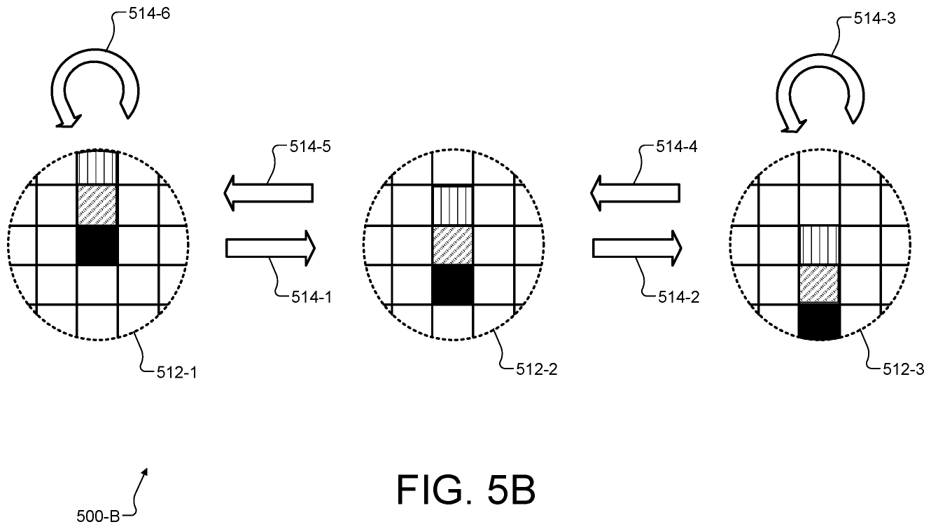

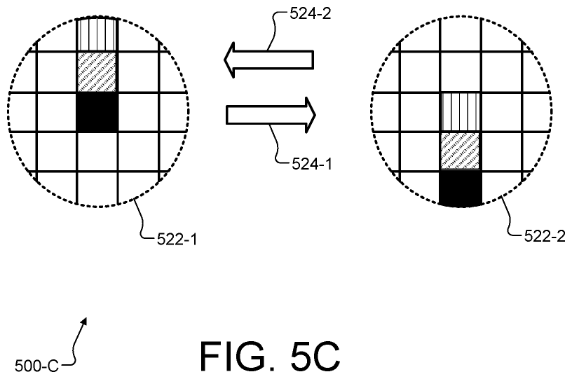

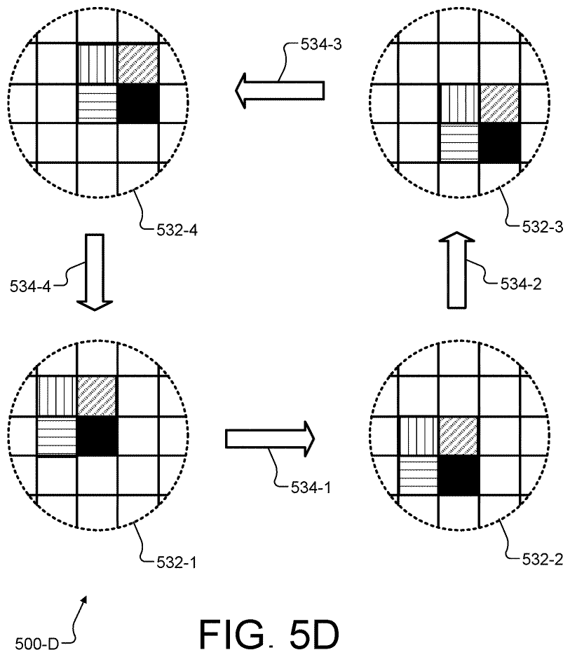

In the example of implementation 100, a one-dimensional (i.e., one-axis), two-position pixel shifting pattern was illustrated in which a pixel panel was non-fractionally shifted up and down by one full pixel. In the examples of implementations 400-A and 400-B, two-dimensional, four-position shifting patterns were illustrated in which the pixel panel was shifted by one full pixel both up and down and left and right with respect to the display. These and various other non-fractional pixel shifting patterns (also referred to as wobulation patterns) may also be implemented as may serve a particular application. Several examples of pixel shifting patterns will now be described and illustrated in relation to FIGS. 5A-5D.

FIG. 5A shows a first illustrative pixel shifting pattern 500-A that may be employed by an implementation of non-fractional pixel shifting to improve pixel performance by mitigating pixel performance disparities in accordance with principles described herein. In this example, an expansion 502-1 associated with a first subframe and an expansion 502-2 associated with a second subframe are shown with transitions 504-1 and 504-2 between them. It will be understood that expansions 502-1 and 502-2 illustrate the same portion of a display, with each of the boxes within the expansions representing pixel positions of the display. However, the shading of certain pixels corresponds to the physical pixels on the pixel panel, such that the shifting of the pixels for each transition is illustrated similarly as shown in FIGS. 4A and 4B. The example of pixel shifting pattern 500-A shows, for instance, a one-dimensional, two-position pixel shifting pattern similar to that of implementation 100. Specifically, the two shaded pixels shift down by one whole pixel at transition 504-1 (moving to positions shown at expansion 502-2) and then shift back up at transition 504-2 (moving back to positions shown at expansion 502-1).

FIG. 5B shows a second illustrative pixel shifting pattern 500-B that may be employed by an implementation of non-fractional pixel shifting to improve pixel performance in accordance with principles described herein. In this example, an expansion 512-1 associated with a first subframe, an expansion 512-2 associated with a second subframe, and an expansion 512-3 associated with a third subframe are shown with transitions 514-1 through 514-6 between them. As with expansions 502-1 and 502-2 of pixel shifting pattern 500-A, it will be understood that expansions 512-1, 512-2, and 512-3 each illustrate the same portion of a display, with each of the boxes within the expansions representing pixel positions of the display. Additionally, the different shading patterns of various pixels again correspond to the physical pixels on the pixel panel. The example of pixel shifting pattern 500-B shows a one-dimensional, three-position pixel shifting pattern. Specifically, the three shaded pixels shift down by one whole pixel at transition 514-1 (moving to positions shown at expansion 512-2), shift down again by one whole pixel at transition 514-2 (moving to positions shown at expansion 512-3), stay in this position for a subframe at transition 514-3 (so that the positions illustrated by expansion 512-2 are not overemphasized over the others), shift back up one whole pixel at transition 514-4 (moving back to positions shown at expansion 512-2), shift back up another whole pixel at transition 514-5 (moving back to positions shown at expansion 512-2), and stay in this position for a subframe at transition 514-6.

Both of the examples of pixel shifting pattern 500-A and pixel shifting pattern 500-B represent one-dimensional patterns in which pixels disposed on a same column of a grid of the pixel panel are shifted, with respect to the display, along a single dimension or axis. While a vertical shift of pixels on a same column are shown in these examples, it will be understood that a horizontal shift of pixels on a same row of the grid could be implemented in a similar way (shifting along the single dimension left and right). Additionally, while pixel shifting patterns 500-A and 500-B involve pixel shifting by one whole pixel at a time, it will be understood that non-fractional pixel shifting need not necessarily move by a single whole pixel at a time, but could move by any integer number of whole pixels as may serve a particular implementation (e.g., essentially skipping pixels between two positions). For example, a first pixel and a second pixel may be disposed non-contiguously on a row or column of a grid of the pixel panel and a pixel controller may cause first light and second light to be displayed at a same pixel position by shifting the pixel panel, with respect to the display, in a manner that skips a third pixel disposed between the first pixel and the second pixel within the row or column.

To illustrate, FIG. 5C shows a third illustrative pixel shifting pattern 500-C that may be employed by an implementation of non-fractional pixel shifting to improve pixel performance in accordance with principles described herein. In this example, an expansion 522-1 associated with a first subframe and an expansion 522-2 associated with a second subframe are shown with transitions 524-1 and 524-2 between them. As with other examples above, it will be understood that expansions 522-1 and 522-2 illustrate the same portion of a display, with each of the boxes within the expansions representing pixel positions of the display. Additionally, the different shading patterns of various pixels again correspond to the physical pixels on the pixel panel.

The example of pixel shifting pattern 500-C shows a one-dimensional, two-position pixel shifting pattern similar to pixel shifting pattern 500-A. However, as shown, the pixel shifting occurring at each transition 524-1 and 524-2 is shown to hop by two whole pixels rather than one. Specifically, the three shaded pixels shift down by two whole pixels at transition 524-1 (moving to positions shown at expansion 522-2) and then shift up again by two whole pixels at transition 524-2 (moving back to positions shown at expansion 522-1). Certain types of defects referred to as cluster defects (e.g., resulting from dust or imperfections on the semiconductor material, etc.) may affect contiguous or proximate clusters of pixels. As such, it may be desirable for pixel groupings to include non-contiguous pixels to help ensure that underperforming pixels are grouped with functional pixels and are not limited only to their immediate (underperforming) neighbors.

FIG. 5D shows a fourth illustrative pixel shifting pattern 500-D that may be employed by an implementation of non-fractional pixel shifting to improve pixel performance in accordance with principles described herein. In this example, an expansion 532-1 associated with a first subframe, an expansion 532-2 associated with a second subframe, an expansion 532-3 associated with a third subframe, and an expansion 532-4 associated with a fourth subframe are shown with transitions 534-1 through 534-4 between them. As with other examples above, it will be understood that expansions 532-1, 532-2, 532-3, and 532-4 each illustrate the same portion of a display, with each of the boxes within the expansions representing pixel positions of the display. Additionally, the different shading patterns of various pixels again correspond to the physical pixels on the pixel panel.

The example of pixel shifting pattern 500-D shows a two-dimensional, four-position pixel shifting pattern similar to that illustrated in implementations 400-A and 400-B. Specifically, the four shaded pixels shift down by one whole pixel at transition 534-1 (moving to positions shown at expansion 532-2), shift right by one whole pixel at transition 534-2 (moving to positions shown at expansion 532-3), shift up by one whole pixel at transition 534-3 (moving to positions shown at expansion 532-4), and shift left one whole pixel at transition 534-4 (moving back to positions shown at expansion 532-1). Accordingly, in this example, a first pixel and a second pixel are disposed on a same row of a grid of the pixel panel, the first pixel and a third pixel are disposed on a same column of the grid, and the pixel controller causes first light, second light, the third light to be displayed at the same pixel position by shifting the pixel panel, with respect to the display, along two dimensions (up-down and left-right).

While FIGS. 5A-5D have illustrated a variety of different pixel shifting patterns to demonstrate how different numbers of dimensions (axes), positions, and shifting patterns (e.g., contiguous vs. non-contiguous) may be used, it will be understood that a variety of other pixel shifting patterns may be implemented using these and similar principles as may serve a particular application. For example, two axes that each have multiple positions may be implemented in one illustrative pixel shifting pattern, a first axis with a first number of positions and a second axis with a different number of positions may be implemented in another illustrative pixel shifting pattern, skipping contiguous pixels along one axis but not the other may be implemented by another illustrative pixel shifting pattern, and so forth in any combination of these types of variations as may serve a particular implementation.

While the focus of the implementations described above has been on non-fractional pixel shifting to improve performance, uniformity, yield, and so forth, it will be understood that fractional pixel shifting techniques (in which a pixel panel is shifted by a fraction of a pixel so as to move pixels to pixel positions that are different from one subframe to another) may also be combined with non-fractional pixel shifting techniques described and illustrated herein. For example, referring to a pixel position of a display such as pixel position 216 that has been described as hosting multiple pixels, certain implementations may further involve an additional pixel position on the display that is separate from pixel position 216 and is offset from a grid on which pixel position 216 is aligned. In this type of example, the pixel controller may further cause the first light emitted by the first pixel to be displayed at the additional pixel position during presentation of certain subframes of the frame. For example, if the frame has four subframes, two of these may be associated with the on-grid pixel position 216 (non-fractional pixel shifting) while the other two may be associated with the off-grid, additional pixel position. As has been described, this type of fractional pixel shifting may help address different types of technical problems than the non-fractional pixel shifting. For example, fractional pixel shifting may help produce a perception of higher resolution on the display (since the off-grid pixel positions may be perceived as different pixels than the on-grid pixel positions), may help reduce the screen-door effect for grids in which there are gaps between pixels, and so forth.

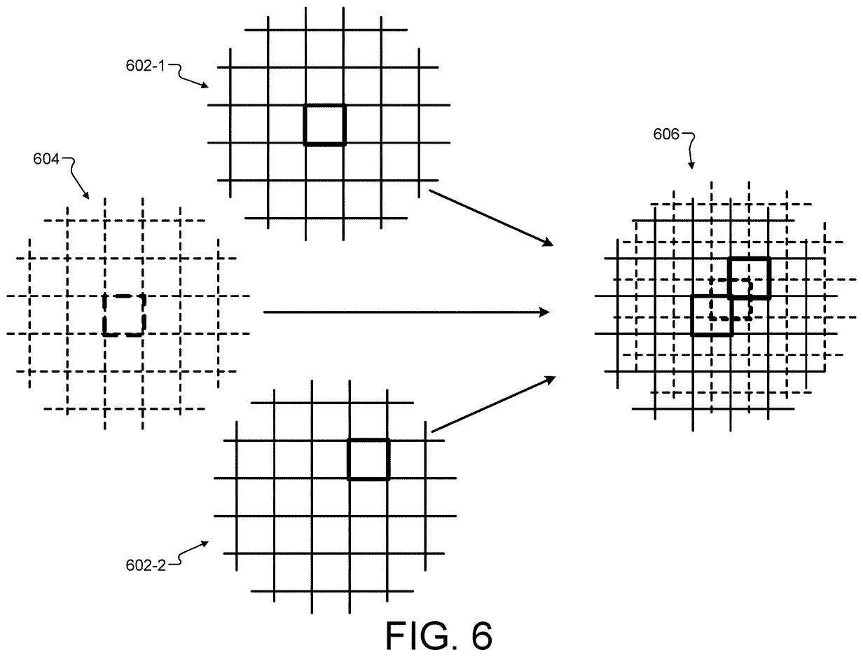

To illustrate a combination of non-fractional and fractional pixel shifting, FIG. 6 shows an illustrative image frame being presented by superimposing subframes with fractional and non-fractional pixel shifting to improve pixel performance and achieve these other objectives in accordance with principles described herein. As shown in FIG. 6, an expansion 602-1 shows a particular bolded pixel that is on-grid for a first sub-frame and an expansion 602-2 shows the same bolded pixel that is non-fractionally shifted (on the same grid) for a second subframe. An expansion 604, however, shows the same bolded pixel on a different grid (off-grid with respect to the other two subframes) that, when superimposed by rapid succession of the subframes as shown in expansion 606, produces an illusion of a new pixel position that is between the other two pixel positions. Accordingly, all the benefits of non-fractional pixel shifting may be achieved in this way along with the objectives of fractional pixel shifting.

As has been mentioned, various methods and processes described herein may be implemented at least in part as instructions embodied in a non-transitory computer-readable medium and executable by one or more computing devices. In general, a processor (e.g., a microprocessor) receives instructions, from a non-transitory computer-readable medium (e.g., a memory, etc.), and executes those instructions, thereby performing one or more operations such as the operations described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random-access memory (DRAM), which typically constitutes a main memory. Common forms of computer-readable media include, for example, a disk, hard disk, magnetic tape, any other magnetic medium, a compact disc read-only memory (CD-ROM), a digital video disc (DVD), any other optical medium, random access memory (RAM), programmable read-only memory (PROM), electrically erasable programmable read-only memory (EPROM), FLASH-EEPROM, any other memory chip or cartridge, or any other tangible medium from which a computer can read.

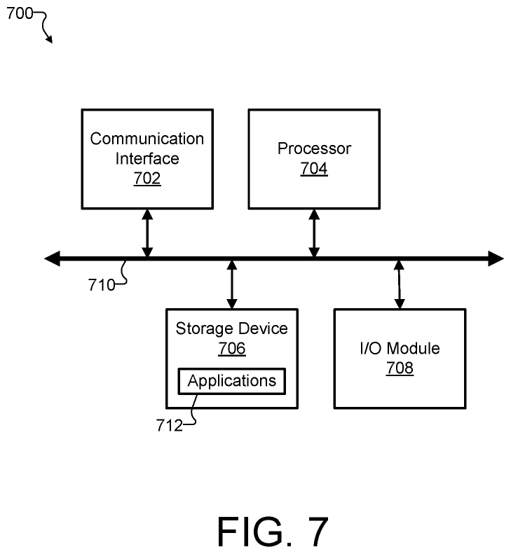

FIG. 7 shows an illustrative computing system 700 that may be used to implement various devices and/or systems described herein. For example, computing system 700 may include or implement (or partially implement) display system 200, any implementations or components thereof, and/or systems described herein that may interoperate with this display system.

As shown in FIG. 7, computing system 700 may include a communication interface 702, a processor 704, a storage device 706, and an input/output (I/O) module 708 communicatively connected via a communication infrastructure 710. While an illustrative computing system 700 is shown in FIG. 7, the components illustrated in FIG. 7 are not intended to be limiting. Additional or alternative components may be used in other embodiments. Components of computing system 700 shown in FIG. 7 will now be described in additional detail.

Communication interface 702 may be configured to communicate with one or more computing devices. Examples of communication interface 702 include, without limitation, a wired network interface (such as a network interface card), a wireless network interface (such as a wireless network interface card), a modem, an audio/video connection, and any other suitable interface.

Processor 704 generally represents any type or form of processing unit capable of processing data or interpreting, executing, and/or directing execution of one or more of the instructions, processes, and/or operations described herein. Processor 704 may direct execution of operations in accordance with one or more applications 712 or other computer-executable instructions such as may be stored in storage device 706 or another computer-readable medium.

Storage device 706 may include one or more data storage media, devices, or configurations and may employ any type, form, and combination of data storage media and/or device. For example, storage device 706 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 706. For example, data representative of one or more executable applications 712 configured to direct processor 704 to perform any of the operations described herein may be stored within storage device 706. In some examples, data may be arranged in one or more databases residing within storage device 706.

I/O module 708 may include one or more I/O modules configured to receive user input and provide user output. One or more I/O modules may be used to receive input for a single virtual experience. I/O module 708 may include any hardware, firmware, software, or combination thereof supportive of input and output capabilities. For example, I/O module 708 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 708 is configured to provide graphical data to a display for presentation to a user. The graphical data may be representative of one or more graphical user interfaces and/or any other graphical content as may serve a particular implementation.

The following examples describe implementations of non-fractional pixel shifting to improve pixel performance by mitigating pixel performance disparities and providing other technical benefits in accordance with principles described herein:
1. A display system comprising: a display for presentation to a user; a pixel panel including a first pixel and a second pixel, the first pixel having a first performance capability with respect to a criterion and the second pixel having a second performance capability with respect to the criterion; and a pixel controller configured to cause the display system to present a frame on the display by performing operations including: causing first light emitted by the first pixel to be displayed at a pixel position on the display during presentation of a first subframe of the frame; and causing second light emitted by the second pixel to be displayed at the pixel position on the display during presentation of a second subframe of the frame.
2. The display system of any of the preceding examples, further comprising a memory storing a plurality of entries indicating measured performance capabilities of the pixel panel; wherein: the plurality of entries includes an entry for a pixel grouping that includes the first pixel and the second pixel; the entry indicates the first performance capability of the first pixel and the second performance capability of the second pixel; and the first light emitted by the first pixel and the second light emitted by the second pixel are based on the entry.
3. The display system of any of the preceding examples, wherein: the pixel grouping further includes a third pixel of the pixel panel, the third pixel having a third performance capability with respect to the criterion and the entry further indicating the third performance capability of the third pixel; the operations further include causing third light emitted by the third pixel to be displayed at the pixel position on the display during presentation of a third subframe of the frame; the first performance capability is more than sufficient to achieve a target performance at the pixel position; the second performance capability is at least sufficient to achieve the target performance at the pixel position; the third performance capability is less than sufficient to achieve the target performance at the pixel position; and based on the entry, the pixel controller causes the first light to be above the target performance, the second light to be at the target performance, and the third light to be below the target performance.
4. The display system of any of the preceding examples, wherein: an additional pixel position on the display is separate from the pixel position and is offset from a grid on which the pixel position is aligned; and the operations further include causing the first light emitted by the first pixel to be displayed at the additional pixel position during presentation of a third subframe of the frame.
5. The display system of any of the preceding examples, wherein: the first pixel and the second pixel are disposed on a same row or column of a grid of the pixel panel; and the pixel controller causes the first light and the second light to be displayed at the pixel position by shifting the pixel panel, with respect to the display, along a single dimension.
6. The display system of any of the preceding examples, wherein: a pixel grouping in which the first pixel and the second pixel are included further includes a third pixel of the pixel panel, the third pixel having a third performance capability with respect to the criterion; the operations further include causing third light emitted by the third pixel to be displayed at the pixel position during presentation of a third subframe of the frame; the first pixel and the second pixel are disposed on a same row of a grid of the pixel panel; the first pixel and the third pixel are disposed on a same column of the grid; and the pixel controller causes the first light, the second light, and the third light to be displayed at the pixel position by shifting the pixel panel, with respect to the display, along two dimensions.
7. The display system of any of the preceding examples, wherein: the first pixel and the second pixel are disposed non-contiguously on a row or column of a grid of the pixel panel; and the pixel controller causes the first light and the second light to be displayed at the pixel position by shifting the pixel panel, with respect to the display, in a manner that skips a third pixel disposed between the first pixel and the second pixel within the row or column.
8. The display system of any of the preceding examples, wherein the criterion is pixel brightness, such that the first performance capability defines how brightly the first pixel is capable of performing and the second performance capability defines how brightly the second pixel is capable of performing.
9. The display system of any of the preceding examples, wherein the criterion is pixel chromaticity, such that the first performance capability defines how close to a nominal color the first pixel is capable of achieving and the second performance capability defines how close to the nominal color the second pixel is capable of achieving.
10. The display system of any of the preceding examples, wherein the criterion is pixel efficiency, such that the first performance capability defines how efficiently the first pixel is capable of performing and the second performance capability defines how efficiently the second pixel is capable of performing.
11. The display system of any of the preceding examples, further comprising: an optical assembly configured to transport the first light from the first pixel to the display and to transport the second light from the second pixel to the display, the optical assembly including an opto-mechanical element; and an actuator configured to displace the opto-mechanical element; wherein the pixel controller causes the first light and the second light to be displayed at the pixel position by directing the actuator to displace the opto-mechanical element such that light emitted by the pixel panel is shifted with respect to the display.
12. The display system of any of the preceding examples, further comprising: an optical assembly configured to transport the first light from the first pixel to the display and to transport the second light from the second pixel to the display; and an actuator configured to displace the pixel panel; wherein the pixel controller causes the first light and the second light to be displayed at the pixel position by directing the actuator to displace the pixel panel such that the pixel panel is shifted with respect to the optical assembly and the display.
13. A method comprising: presenting, on a display of a display system, a frame that includes a first subframe and a second subframe, wherein the display system includes the display and a pixel panel including a first pixel having a first performance capability with respect to a criterion and a second pixel having a second performance capability with respect to the criterion; configuring the display system such that first light emitted by the first pixel is displayed at a pixel position on the display during presentation of the first subframe; and configuring the display system such that second light emitted by the second pixel is displayed at the pixel position during presentation of the second subframe.
14. The method of any of the preceding examples, further comprising accessing an entry from a plurality of entries stored in a memory to indicate measured performance capabilities of the pixel panel; wherein: the entry corresponds to a pixel grouping that includes the first pixel and the second pixel; the entry indicates the first performance capability of the first pixel and the second performance capability of the second pixel; and the first light emitted by the first pixel and the second light emitted by the second pixel are based on the entry.
15. The method of any of the preceding examples, wherein: the pixel grouping further includes a third pixel of the pixel panel, the third pixel having a third performance capability with respect to the criterion and the entry further indicating the third performance capability of the third pixel; the method further comprises causing third light emitted by the third pixel to be displayed at the pixel position on the display during presentation of a third subframe of the frame; the first performance capability is more than sufficient to achieve a target performance at the pixel position; the second performance capability is at least sufficient to achieve the target performance at the pixel position; the third performance capability is less than sufficient to achieve the target performance at the pixel position; and based on the entry, the first light is emitted above the target performance, the second light is emitted at the target performance, and the third light is emitted below the target performance.
16. The method of any of the preceding examples, wherein the criterion is pixel brightness, such that the first performance capability defines how brightly the first pixel is capable of performing and the second performance capability defines how brightly the second pixel is capable of performing.
17. The method of any of the preceding examples, wherein: the display system further includes: an optical assembly configured to transport the first light from the first pixel to the display and to transport the second light from the second pixel to the display, the optical assembly including an opto-mechanical element; and an actuator configured to displace the opto-mechanical element; and the display system is configured to cause the first light and the second light to be displayed at the pixel position by directing the actuator to displace the opto-mechanical element such that light emitted by the pixel panel is shifted with respect to the display.
18. A non-transitory computer-readable medium storing instructions that, when executed, cause a pixel controller of a display system to perform a process comprising: presenting, on a display of the display system, a frame that includes a first subframe and a second subframe, wherein the display system includes the display and a pixel panel including a first pixel having a first performance capability with respect to a criterion and a second pixel having a second performance capability with respect to the criterion; configuring the display system such that first light emitted by the first pixel is displayed at a pixel position on the display during presentation of the first subframe; and configuring the display system such that second light emitted by the second pixel is displayed at the pixel position during presentation of the second subframe.
19. The non-transitory computer-readable medium of any of the preceding examples, wherein: the process further comprises accessing an entry from a plurality of data entries stored in a memory to indicate measured performance capabilities of the pixel panel; the entry corresponds to a pixel grouping that includes the first pixel and the second pixel; the entry indicates the first performance capability of the first pixel and the second performance capability of the second pixel; and the first light emitted by the first pixel and the second light emitted by the second pixel are based on the entry.
20. The non-transitory computer-readable medium of any of the preceding examples, wherein: the pixel grouping further includes a third pixel of the pixel panel, the third pixel having a third performance capability with respect to the criterion and the entry further indicating the third performance capability of the third pixel; the process further comprises causing third light emitted by the third pixel to be displayed at the pixel position on the display during presentation of a third subframe of the frame; the first performance capability is more than sufficient to achieve a target performance at the pixel position; the second performance capability is at least sufficient to achieve the target performance at the pixel position; the third performance capability is less than sufficient to achieve the target performance at the pixel position; and based on the entry, the pixel controller causes the first light to be above the target performance, the second light to be at the target performance, and the third light to be below the target performance.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A number of implementations have been described. Nevertheless, it will be understood that various modifications may be made without departing from the spirit and scope of the description and claims. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Specific structural and functional details disclosed herein are merely representative for purposes of describing example implementations. Example implementations, however, may be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. A first element could be termed a second element, and, similarly, a second element could be termed a first element, without departing from the scope of the implementations of the disclosure. As used herein, the term and/or includes any and all combinations of one or more of the associated listed items.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized, or location information may be obtained (such as to a city, zip code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes, and equivalents may occur to those skilled in the art. It is therefore to be understood that the appended claims are intended to cover such modifications and changes as fall within the scope of the implementations. It will be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described. As such, the scope of the present disclosure is not limited to the particular combinations hereafter claimed, but instead extends to encompass any combination of features or example implementations described herein irrespective of whether or not that particular combination has been specifically enumerated in the accompanying claims at this time.

1. A display system comprising:
a display for presentation to a user;
a pixel panel including a first pixel and a second pixel, the first pixel having a first performance capability with respect to a criterion and the second pixel having a second performance capability with respect to the criterion; and
a pixel controller configured to cause the display system to present a frame on the display by performing operations including:
causing first light emitted by the first pixel to be displayed at a pixel position on the display during presentation of a first subframe of the frame; and
causing second light emitted by the second pixel to be displayed at the pixel position on the display during presentation of a second subframe of the frame.

2. The display system of claim 1, further comprising a memory storing a plurality of entries indicating measured performance capabilities of the pixel panel;
wherein:
the plurality of entries includes an entry for a pixel grouping that includes the first pixel and the second pixel;
the entry indicates the first performance capability of the first pixel and the second performance capability of the second pixel; and
the first light emitted by the first pixel and the second light emitted by the second pixel are based on the entry.

3. The display system of claim 2, wherein:
the pixel grouping further includes a third pixel of the pixel panel, the third pixel having a third performance capability with respect to the criterion and the entry further indicating the third performance capability of the third pixel;
the operations further include causing third light emitted by the third pixel to be displayed at the pixel position on the display during presentation of a third subframe of the frame;
the first performance capability is more than sufficient to achieve a target performance at the pixel position;
the second performance capability is at least sufficient to achieve the target performance at the pixel position;
the third performance capability is less than sufficient to achieve the target performance at the pixel position; and
based on the entry, the pixel controller causes the first light to be above the target performance, the second light to be at the target performance, and the third light to be below the target performance.

4. The display system of claim 1, wherein:
an additional pixel position on the display is separate from the pixel position and is offset from a grid on which the pixel position is aligned; and
the operations further include causing the first light emitted by the first pixel to be displayed at the additional pixel position during presentation of a third subframe of the frame.

5. The display system of claim 1, wherein:
the first pixel and the second pixel are disposed on a same row or column of a grid of the pixel panel; and
the pixel controller causes the first light and the second light to be displayed at the pixel position by shifting the pixel panel, with respect to the display, along a single dimension.

6. The display system of claim 1, wherein:
a pixel grouping in which the first pixel and the second pixel are included further includes a third pixel of the pixel panel, the third pixel having a third performance capability with respect to the criterion;
the operations further include causing third light emitted by the third pixel to be displayed at the pixel position during presentation of a third subframe of the frame;
the first pixel and the second pixel are disposed on a same row of a grid of the pixel panel;
the first pixel and the third pixel are disposed on a same column of the grid; and
the pixel controller causes the first light, the second light, and the third light to be displayed at the pixel position by shifting the pixel panel, with respect to the display, along two dimensions.

7. The display system of claim 1, wherein:
the first pixel and the second pixel are disposed non-contiguously on a row or column of a grid of the pixel panel; and
the pixel controller causes the first light and the second light to be displayed at the pixel position by shifting the pixel panel, with respect to the display, in a manner that skips a third pixel disposed between the first pixel and the second pixel within the row or column.

8. The display system of claim 1, wherein the criterion is pixel brightness, such that the first performance capability defines how brightly the first pixel is capable of performing and the second performance capability defines how brightly the second pixel is capable of performing.

9. The display system of claim 1, wherein the criterion is pixel chromaticity, such that the first performance capability defines how close to a nominal color the first pixel is capable of achieving and the second performance capability defines how close to the nominal color the second pixel is capable of achieving.

10. The display system of claim 1, wherein the criterion is pixel efficiency, such that the first performance capability defines how efficiently the first pixel is capable of performing and the second performance capability defines how efficiently the second pixel is capable of performing.

11. The display system of claim 1, further comprising:
an optical assembly configured to transport the first light from the first pixel to the display and to transport the second light from the second pixel to the display, the optical assembly including an opto-mechanical element; and
an actuator configured to displace the opto-mechanical element;
wherein the pixel controller causes the first light and the second light to be displayed at the pixel position by directing the actuator to displace the opto-mechanical element such that light emitted by the pixel panel is shifted with respect to the display.

12. The display system of claim 1, further comprising:
an optical assembly configured to transport the first light from the first pixel to the display and to transport the second light from the second pixel to the display; and
an actuator configured to displace the pixel panel;
wherein the pixel controller causes the first light and the second light to be displayed at the pixel position by directing the actuator to displace the pixel panel such that the pixel panel is shifted with respect to the optical assembly and the display.

13. A method comprising:
presenting, on a display of a display system, a frame that includes a first subframe and a second subframe, wherein the display system includes the display and a pixel panel including a first pixel having a first performance capability with respect to a criterion and a second pixel having a second performance capability with respect to the criterion;
configuring the display system such that first light emitted by the first pixel is displayed at a pixel position on the display during presentation of the first subframe; and
configuring the display system such that second light emitted by the second pixel is displayed at the pixel position during presentation of the second subframe.

14. The method of claim 13, further comprising accessing an entry from a plurality of entries stored in a memory to indicate measured performance capabilities of the pixel panel;
wherein:
the entry corresponds to a pixel grouping that includes the first pixel and the second pixel;
the entry indicates the first performance capability of the first pixel and the second performance capability of the second pixel; and
the first light emitted by the first pixel and the second light emitted by the second pixel are based on the entry.

15. The method of claim 14, wherein:
the pixel grouping further includes a third pixel of the pixel panel, the third pixel having a third performance capability with respect to the criterion and the entry further indicating the third performance capability of the third pixel;
the method further comprises causing third light emitted by the third pixel to be displayed at the pixel position on the display during presentation of a third subframe of the frame;
the first performance capability is more than sufficient to achieve a target performance at the pixel position;
the second performance capability is at least sufficient to achieve the target performance at the pixel position;
the third performance capability is less than sufficient to achieve the target performance at the pixel position; and
based on the entry, the first light is emitted above the target performance, the second light is emitted at the target performance, and the third light is emitted below the target performance.

16. The method of claim 13, wherein the criterion is pixel brightness, such that the first performance capability defines how brightly the first pixel is capable of performing and the second performance capability defines how brightly the second pixel is capable of performing.

17. The method of claim 13, wherein:
the display system further includes:
an optical assembly configured to transport the first light from the first pixel to the display and to transport the second light from the second pixel to the display, the optical assembly including an opto-mechanical element; and
an actuator configured to displace the opto-mechanical element; and
the display system is configured to cause the first light and the second light to be displayed at the pixel position by directing the actuator to displace the opto-mechanical element such that light emitted by the pixel panel is shifted with respect to the display.

18. A non-transitory computer-readable medium storing instructions that, when executed, cause a pixel controller of a display system to perform a process comprising:
presenting, on a display of the display system, a frame that includes a first subframe and a second subframe, wherein the display system includes the display and a pixel panel including a first pixel having a first performance capability with respect to a criterion and a second pixel having a second performance capability with respect to the criterion;
configuring the display system such that first light emitted by the first pixel is displayed at a pixel position on the display during presentation of the first subframe; and
configuring the display system such that second light emitted by the second pixel is displayed at the pixel position during presentation of the second subframe.

19. The non-transitory computer-readable medium of claim 18, wherein:
the process further comprises accessing an entry from a plurality of data entries stored in a memory to indicate measured performance capabilities of the pixel panel;
the entry corresponds to a pixel grouping that includes the first pixel and the second pixel;
the entry indicates the first performance capability of the first pixel and the second performance capability of the second pixel; and
the first light emitted by the first pixel and the second light emitted by the second pixel are based on the entry.

20. The non-transitory computer-readable medium of claim 19, wherein:
the pixel grouping further includes a third pixel of the pixel panel, the third pixel having a third performance capability with respect to the criterion and the entry further indicating the third performance capability of the third pixel;
the process further comprises causing third light emitted by the third pixel to be displayed at the pixel position on the display during presentation of a third subframe of the frame;
the first performance capability is more than sufficient to achieve a target performance at the pixel position;
the second performance capability is at least sufficient to achieve the target performance at the pixel position;
the third performance capability is less than sufficient to achieve the target performance at the pixel position; and
based on the entry, the pixel controller causes the first light to be above the target performance, the second light to be at the target performance, and the third light to be below the target performance.
